(19) United States
(12) Patent Application Publication
(10) Pub. No.: US 2007/0182081 A1
(43) Pub. Date: Aug. 9, 2007

(54) SPIN UNIT IN WAFER SPINNER APPARATUS AND METHOD OF REPOSITIONING SPIN UNIT

(76) Inventor: Seok-gi Si, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/610,670

(22) Filed: Dec. 14, 2006

(30) Foreign Application Priority Data
Feb. 9, 2006 (KR) 10-2006-0012582

(51) Int. Cl. B23Q 1/64; B05C 13/00

(52) U.S. Cl. 269/57; 118/320; 118/52; 118/712; 269/329; 118/500; 438/109

(57) ABSTRACT

A wafer spinner apparatus includes a main body, and a plurality of spin units disposed in the main body to open and close in a rack configuration, each spin unit including a stepping motor disposed in the main body to move a spin unit in a horizontal direction, a base plate coupled to the stepping motor, a reference sensor disposed in the main body to determine a position deviation of the spin unit, and a spin chuck disposed on the base plate.

### CROSS-REFERENCE TO RELATED PATENT APPLICATION

This application claims priority to Korean Patent Application No. 10-2006-0012582, filed on Feb. 9, 2006, the disclosure of which is incorporated herein in its entirety by reference.

### BACKGROUND OF THE INVENTION

1. Technical Field

The present disclosure relates to a wafer spinner apparatus used in a photolithography process and an operating method thereof, and more particularly, to a wafer spinner apparatus with a spin unit stacked in a rack configuration.

2. Discussion of the Related Art

A photolithography process used for manufacturing a semiconductor device includes a pre-process of increasing adhesion between a wafer and a photoresist, coating a photoresist on a semiconductor wafers a post-process of increasing the adhesion between the wafer and the photoresist, an exposure process of illuminating light on a semiconductor wafer coated with the photoresist using a mask and a development process of removing a portion of the photoresist depolymerised by the exposure to form a photoresist pattern. A wafer spinner apparatus is used to coat the photoresist on the surface of the semiconductor wafer during the photolithography process.

FIG. 1 is a side view of a spin unit of a wafer spinner apparatus.

Referring to FIG. 1, a spin unit 50 includes a robot arm (not shown) that positions a semiconductor wafer 12 on a rotating spin chuck 10. After the semiconductor wafer 12 is placed on the spin chuck 10, the spin chuck 10 rotates. When a photoresist (PR) dispenser 14 sprays the photoresist onto the semiconductor wafer 12 placed on the spin chuck 10, the spin chuck 10 spins the semiconductor wafer 12 so that the generated centrifugal force evenly coats the semiconductor wafer 12 with the photoresist.

However, when the spin unit 50 is opened for preventive maintenance (PM), the initial central axis (I-I′) of the spin chuck 10 deviates to an axis (II-II′). Then, a nozzle 16 in a fixed position sprays a solvent such as a thinner on the periphery of the semiconductor wafer 12 for rinsing. This causes an edge bead removal (EBR) defect at the edge of the semiconductor wafer 12.

FIGS. 2 and 3 are perspective views of opened and closed spin units configured in a rack to facilitate PM of a wafer spinner apparatus. FIG. 4 is a detailed perspective view illustrating the opening and closing of the spin unit 50.

Referring to FIGS. 2 through 4, a wafer spinner apparatus has a stacked structure of 2 to 5 layers for efficient use of space. Each spin unit 50 is configured in a is rack, as shown in FIGS. 2 and 3. The spin units 50 in FIG. 2 are in a closed state. The spin unit 50 positioned under another spin unit 50 in FIG. 3 is in an open state for maintenance.

In a rack configuration one spin unit 50 is positioned over another spin unit 50, such that the spin unit 50 positioned lower should be pulled out to perform maintenance. To pull the spin unit 50 out, a fixing screw (not shown) coupled to the spin unit 50 is unscrewed, and the spin unit 50 slides over rails 52 when pulled out using a handle 54. When the handle 54 is pushed, the spin unit 50 returns to its original position and is closed.

However, the movement of the spin unit 50 can cause a gap during the opening and closing of the spin unit 50, so that the central axis of the spin shaft configured within the spin unit 50 is dislocated. Thus, the position shift of the spin unit 50, as shown in FIG. 1, can cause an EBR defect, thereby increasing the defect rate of chips taken from the periphery of the semiconductor wafer. A longer repair time is required because the deviated position of the spin unit 50 must be adjusted to the original position after the maintenance procedure.

### SUMMARY OF THE INVENTION

An exemplary embodiment of the present invention provides a wafer spinner apparatus for repositioning a spin unit to the original position.

An exemplary embodiment of the present invention provides a method of operating a wafer spinner apparatus for repositioning a spin unit to the original position.

According to an exemplary embodiment of the present invention, a wafer spinner apparatus comprises a main body, and a plurality of spin units disposed in the main body to open and close in a rack configuration, each spin unit including a stepping motor disposed in the main body to move a spin unit in a horizontal direction, a base plate coupled to the stepping motor, a reference sensor disposed in the main body to determine a position deviation of the spin unit, and a spin chuck disposed on the base plate.

The stepping motor can be connected to the base plate through a screw.

The base plate mounting the spin unit may comprise two linear motion guides for moving the spin unit.

The spin unit may further include a first so-called sector disposed on a sidewall of the spin unit that corresponds to a position of the reference sensor, and a second sector disposed on a lower portion of the sidewall to operate another sensor.

The spin unit may further include a home sensor disposed in the main body to detect an initial position of the spin unit.

The spin unit may further include an open sensor installed in the main body to detect an open state of the spin unit.

The spin unit may further include a limit sensor disposed in the main body to detect a maximum open position of the spin unit.

The reference sensor can be a light sensor.

The light sensor may comprise a light emitting part and a light receiving part.

The light sensor can measure an amount of received light in terms of a numeric value.

The stepping motor can be connected to an encoder.

The stepping motor connected to the encoder can be connected to a main controller of the main body.

The stepping motor may include a signal line connected to an external portable panel controlling the stepping motor.

The limit sensor may generate an interlock signal such that a brake operates when the spin unit is opened beyond the maximum open position.

The position deviation of the spin unit can be determined through simultaneous operations of an initial position checking pulse from the stepping motor and the reference sensor.

According to an exemplary embodiment of the present invention, a method of repositioning a spin unit in a wafer spinner apparatus comprises preparing a wafer spinner apparatus including a plurality of spin units in a rack, opening the spin unit using a stepping motor disposed in the wafer spinner apparatus closing the spin unit and returning the spin unit to an initial position using the stepping motor, and checking the initial position of the spin unit using an initial position checking pulse of the stepping motor and a reference sensor disposed in the wafer spinner apparatus.

The reference sensor may be a light sensor having a light emitting part and a light receiving part, and opening and closing of the spin unit may be performed through a portable panel connected to the stepping motor.

### BRIEF DESCRIPTION OF THE DRAWINGS

Exemplary embodiments of the present disclosure can be understood in more detail from the following descriptions taken in conjunction with the accompanying drawings in which:

FIG. 1 is a side view of a spin unit of a wafer spinner apparatus;

FIGS. 2 and 3 are perspective views of opened and closed spin units configured in a rack to facilitate PM of a wafer spinner apparatus;

FIG. 4 is a detailed perspective view illustrating the opening and closing of a spin unit;

FIGS. 5 and 6 are side views illustrating a closed spin unit and an opened spin unit, respectively, according to an exemplary embodiment of the present invention;

FIGS. 7 and 8 are plan views illustrating a closed spin unit and an opened spin unit, respectively, according to an exemplary embodiment of the present invention;

FIG. 9 is a block diagram illustrating an electrical connection of a stepping motor for moving a spin unit according to an exemplary embodiment of the present invention;

FIGS. 10 through 12 are schematic diagrams illustrating a method of operating a reference sensor used in a wafer spinner apparatus according to an exemplary embodiment of the present invention; and

FIG. 13 is a flowchart illustrating a method of operating a wafer spinner apparatus for repositioning a spin unit according to an exemplary embodiment of the present invention.

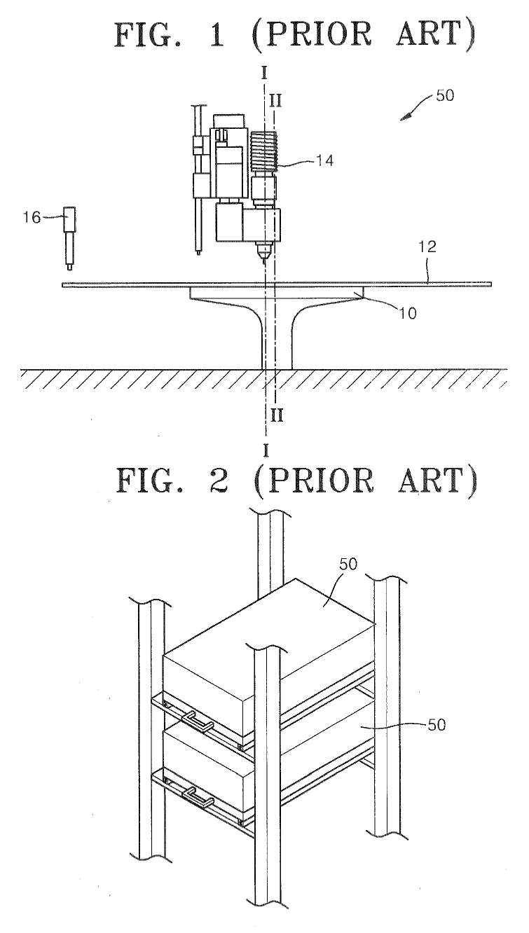

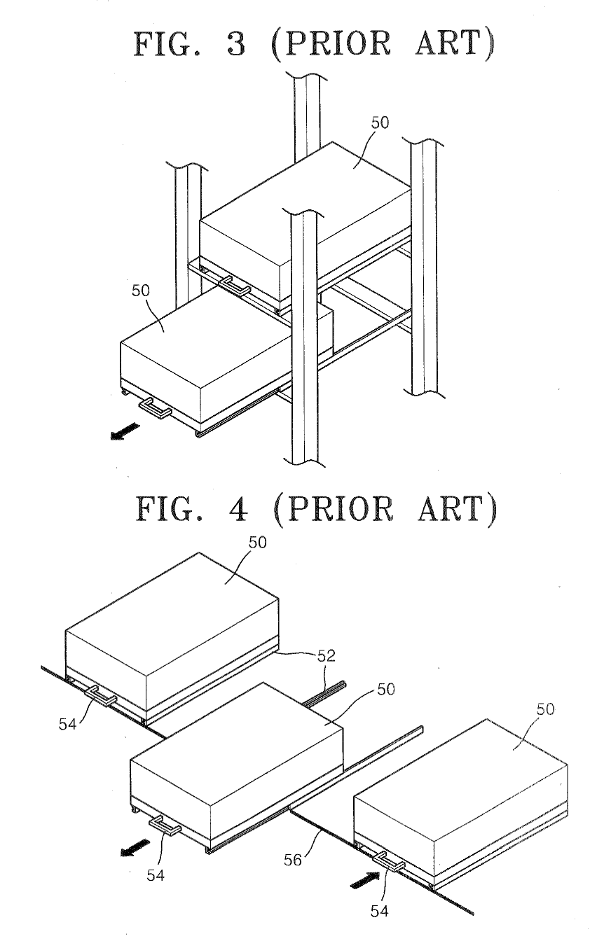

### DETAILED DESCRIPTION OF EXEMPLARY EMBODIMENTS

Exemplary embodiments of the present invention will be described below in more detail with reference to the accompanying drawings. The present invention may be embodied in many different forms and should not be construed as limited to the embodiments set forth herein.

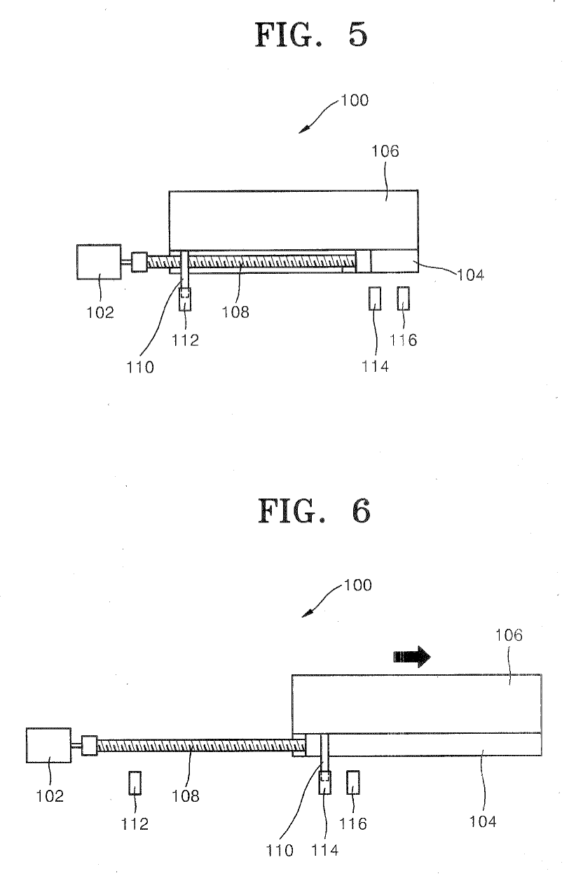

FIG. 5 is a side view of a closed spin unit according to an exemplary embodiment of the present invention. FIG. 6 is a side view of an open spin unit according to an exemplary embodiment of the present invention. The wafer spinner apparatus includes a stepping motor 102 for conveying a spin unit 106 configured in a rack to one end of a screw 108 in a main body 100. The stepping motor 12 is mechanically coupled to a base plate 104 using the screw 108. In an exemplary embodiment, the spin unit 106 that includes a spin chuck is fixedly disposed above the base plate 104.

A second sector 110, for use in operating various sensors 112, 114, and 116 below the spin unit 106, is disposed to detect and control the position of the spin unit 106.

A home sensor 112 can detect the initial position of the spin unit 106 within the wafer spinner apparatus. An open sensor 114 can detect if the spin unit 106 is in an open position. A limit sensor 116 can detect the maximum opening point of the spin unit 106. When the spin unit 106 reaches or extends beyond the maximum opening point and the limit sensor 116 detects the second sector 110, the main controller of the wafer spinner apparatus generates an interlock signal so that the stepping motor 102 stops the spin unit 106.

In an exemplary embodiment, an interlock signal may be generated when a sudden power failure or an overload on the stepping motor 102 occurs.

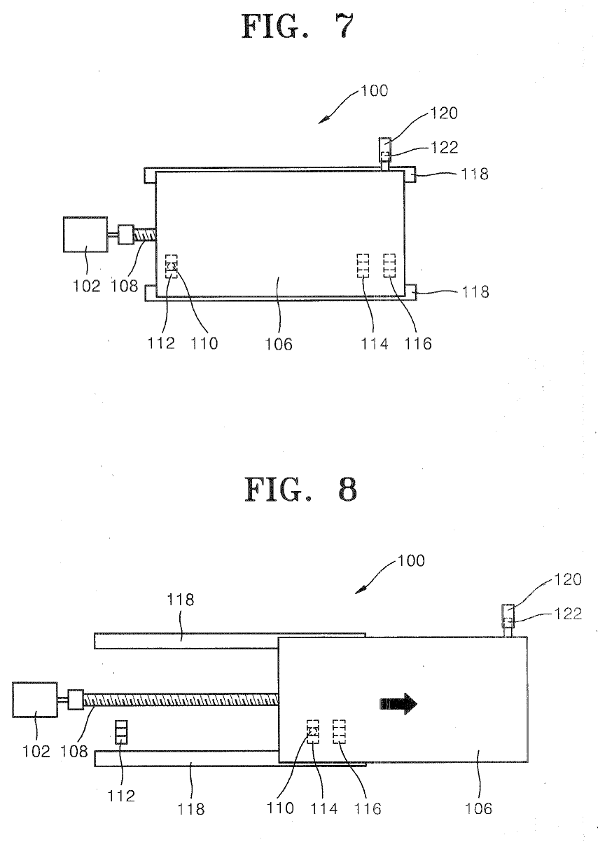

FIGS. 7 and 8 are plan views of FIGS. 5 and 6, respectively. Referring to FIGS. 7 and 8, the base plate (104 in FIG. 6) supporting the spin unit 106 can convey the spin unit 106 when opening and closing the spin unit 106. The base plate 104 is connected to a linear motion (LM) guide 118 that prevents twisting of the spin unit 106 around the screw 108 due to a weight unbalance. Accordingly, the rotation of the stepping motor 102 operates the screw 108 and the LM guide 118 collaboratively to open and close the spin unit 106.

A first sector 122 is a detecting component for the operation of the sensors. The first sector 122 is disposed on a sidewall of the spin unit 106 according to an exemplary embodiment of the present invention. A reference sensor 120 is disposed at a portion of the main body 100 of the wafer spinner apparatus that corresponds to the position of the first sector 122. The reference sensor 120 detects if the spin unit 106 returns to the initial position after the spin unit 106 is closed. In an exemplary embodiment of the present invention, the wafer spinner apparatus employs an initial position checking pulse used by the stepping motor 102, and the reference sensor 120 detects whether the spin unit 106 has returned to the initial position when the spin unit 106 is closed.

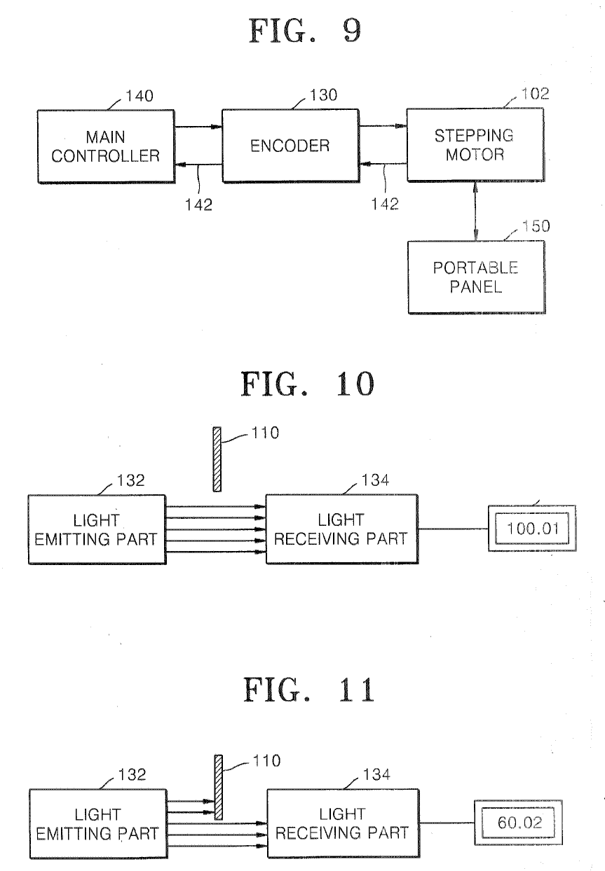

FIG. 9 is a block diagram illustrating the electrical connection of the stepping motor 102 for moving the spin unit 106 according to an exemplary embodiment of the present invention.

Referring to FIG. 9, the stepping motor 102 may be connected to an external portable panel 150 and may include a signal line connecting part for controlling the operation of the stepping motor 102. The portable panel 150 can be a portable auxiliary device with keys and a display for controlling the stepping motor 102 according to an exemplary embodiment of the present invention. The stepping motor 102 can be electrically connected through a signal line 142 to an encoder 130. The encoder 130 detects the moving distance of the spin unit 106 during the operation of the stepping motor 102, and coverts the data into an electrical signal. The converted electrical signal is transferred to the main controller 140. The encoder 130 is electrically connected to the main controller 140 through the signal line 142 for transferring the interlock signal.

FIGS. 10 through 12 are schematic diagrams illustrating a method of operating a reference sensor used in a wafer spinner apparatus according to an exemplary embodiment of the present invention.

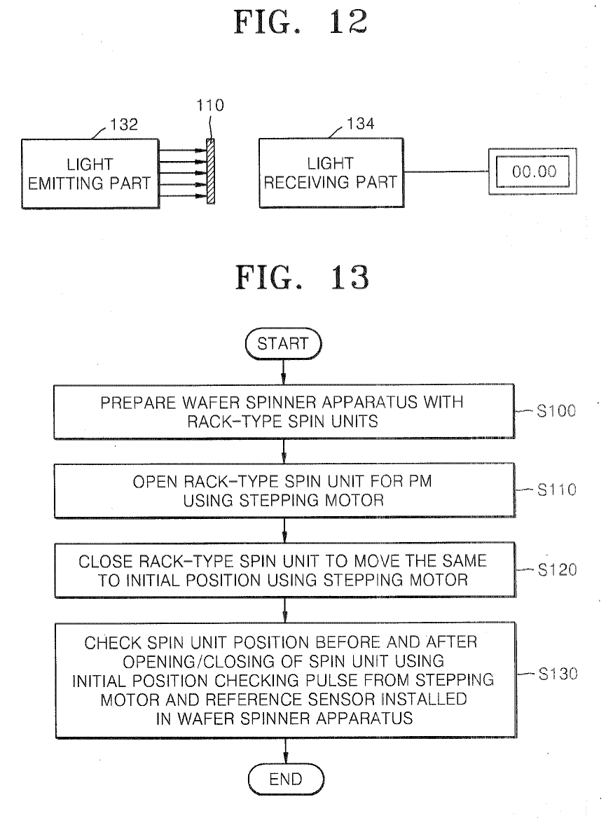

Referring to FIGS. 10 through 12, the home sensor 112, the open sensor 114, the limit sensor 116, and the reference sensor 120 of FIGS. 7 and 8 can be light sensors that include an emitting part 132 and a receiving part 134. When first and second sectors 122, 110 disposed on the spin unit 106 move, the amount of received light can be measured as a digitalized numeric value. FIG. 10 shows that the second sector 110 blocks none of the light emitted from the light emitting part 132. Thus, the entire the light emitted from the light emitting part 132 can be received by the light receiving part 134. FIG. 11 shows that the second sector 110 blocks some of light emitted from the light emitting part 132. Thus, only some of the light emitted from the light emitting part 132 can be received by the light receiving part 134. FIG. 12 shows that the second sector 110 blocks the entire light emitted from the light emitting part 132. Thus, none of the light emitted from the light emitting part 132 can reach the light receiving part 134. Accordingly, the moving distance and the current position of the spin unit 106 can be precisely determined.

FIG. 13 is a flowchart illustrating a method of operating a wafer spinner apparatus for repositioning a spin unit according to an exemplary embodiment of the present invention.

Referring to FIG. 13, a wafer spinner apparatus, having a plurality of opening and closing spin units in a rack as described in, for example, FIGS. 4 through 12 is prepared in step S100. Then, a stepping motor disposed inside the wafer spinner apparatus is used to open a spin unit for conducting preventive maintenance (PM) in step S110. When the preventive maintenance (PM) is completed, the stepping motor is used to return and close the spin unit in a rack to its original position in step S120. After the spin unit is closed, the initial position checking pulse used by the stepping motor and the reference sensor disposed inside the wafer spinner apparatus are measured simultaneously to determine whether the spin unit has returned to the initial position in step S130.

The first sector 122 may be installed on a sidewall of the spin unit 106for the operation of the reference sensor 120, which can be a light sensor with an emitting part 132 and a receiving part 134 The opening and closing of the spin unit 106 may be achieved by operating the portable panel 150 connected to the stepping motor 102. The wafer spinner apparatus may be designed to activate a stopping action by the stepping motor 102 when a built-in limit sensor detects that the spin unit 106 is excessively opened.

If it is detected that the spin unit 106 has not returned to the initial position, the position of the reference sensor 120 disposed in the wafer spinner apparatus may be adjusted or the initial position checking pulse value of the stepping motor 102 may be compensated to adjust the initial position of the spin unit 106.

According to an exemplary embodiment of the present invention, the initial position of a spin unit 106 can be determined through operations of the stepping motor 102 and the reference sensor 120 when opening and closing the spin unit 106 for preventive maintenance (PM). Thus, the return of the spin unit 106 to the initial position without deviation can be facilitated. Accordingly, chips taken from the periphery of a semiconductor wafer have a lower defect rate.

According to an exemplary embodiment of the present invention, preventive maintenance (PM) efficiency can be increased because the time for repositioning a spin unit is reduced.

According to an exemplary embodiment of the present invention, abnormal positions of a spin unit that may arise during a manual operation can be prevented by a stopping operation through the limit sensor.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A wafer spinner apparatus comprising:
a main body; and
a plurality of spin units disposed in the main body to open and close in a rack configuration, each spin unit including:
a stepping motor disposed in the main body to move a selected spin unit in a horizontal direction;
a base plate coupled to the stepping motor;
a reference sensor disposed in the main body to determine a position deviation of the spin unit; and
a spin chuck disposed on the base plate.

2. The wafer spinner apparatus of claim 1, wherein the stepping motor is connected to the base plate through a screw.

3. The wafer spinner apparatus of claim 1, wherein the base plate supporting the spin unit comprises two linear motion guides for moving the spin unit.

4. The wafer spinner apparatus of claim 1, wherein the spin unit further includes a first sector disposed on a sidewall of the spin unit that corresponds to a position of the reference sensor, and a second sector disposed on a lower portion of the sidewall to operate another sensor.

5. The wafer spinner apparatus of claim 1, wherein the spin unit further includes a home sensor disposed in the main body to detect an initial position of the spin unit.

6. The wafer spinner apparatus of claim 1, wherein the spin unit further includes an open sensor installed in the main body to detect an open state of the spin unit.

7. The wafer spinner apparatus of claim 1, wherein the spin unit further includes a limit sensor disposed in the main body to detect a maximum open position of the spin unit.

8. The wafer spinner apparatus of claim 1, wherein the reference sensor is a light sensor.

9. The wafer spinner apparatus of claim 8, wherein the light sensor comprises a light emitting part and a light receiving part.

10. The wafer spinner apparatus of claim 8, wherein the light sensor measures an amount of received light in terms of a numeric value.

11. The wafer spinner apparatus of claim 1, wherein the stepping motor is connected to an encoder.

12. The wafer spinner apparatus of claim 11, wherein the stepping motor connected to the encoder is connected to a main controller of the main body.

13. The wafer spinner apparatus of claim 12, wherein the stepping motor includes a signal line connected to an external portable panel controlling the stepping motor.

14. The wafer spinner apparatus of claim 7, wherein the limit sensor generates an interlock signal such that a brake operates when the spin unit is opened beyond the maximum open position.

15. The wafer spinner apparatus of claim 1, wherein the position deviation of the spin unit is determined through simultaneous operations of an initial position checking pulse from the stepping motor and the reference sensor.

16. A method of repositioning a spin unit in a wafer spinner apparatus, the method comprising;
preparing a wafer spinner apparatus including a plurality of spin units in a rack configuration;
opening the spin unit using a stepping motor disposed in the wafer spinner apparatus;
closing the spin unit and returning the spin unit to an initial position using the stepping motor; and
checking the initial position of the spin unit using an initial position checking pulse of the stepping motor and a reference sensor disposed in the wafer spinner apparatus.

17. The method of claim 16, wherein a first sector is disposed on a sidewall of the spin unit.

18. The method of claim 16, wherein the reference sensor is a light sensor having a light emitting part and a light receiving part.

19. The method of claim 16, wherein opening and closing of the spin unit is performed through a portable panel connected to the stepping motor.

20. The method of claim 16, wherein the wafer spinner apparatus further includes a limit sensor sensing excessive opening of the spin unit to operate a brake when the spin unit is opened excessively.
